(19) United States
(12) Patent Application Publication
(10) Pub. No.: US 2016/0028783 A1
(43) Pub. Date: Jan. 28, 2016

(54) SYSTEM FOR SIMULTANEOUS REMOTE MANAGEMENT OF DOCUMENTS

(71) Applicant: PHONETICA LAB S.R.L., Paderno Dugnano (IT)

(72) Inventors: Giuseppe DURANTE, Arese (IT); Raoul TREVISI, Arconate (IT)

(21) Appl. No.: 14/774,890

(22) PCT Filed: Mar. 11, 2014
(86) PCT No.: PCT/EP2014/054670

§ 371 Date: Sep. 11, 2015

(30) Foreign Application Priority Data
Mar. 12, 2013 (IT) MI2013A000371

(51) Int. Cl. H04L 29/06; G06F 3/0481

(52) U.S. Cl. CPC H04L 65/4015; H04L 65/403; G06F 3/04817

(57) ABSTRACT

A system for defining and sharing a document in electronic format is provided. The system includes a master electronic device and at least one slave electronic device, each one of the master and slave devices having at least one processing unit, and a display for displaying the document and elements for telematic data exchange. The master and slave devices are configured to simultaneously show a same view of the document on the displays. The master device includes a processor for modifying the document. The slave device includes elements for applying a digital signature on the document.

The present invention relates to a system for sharing information, particularly to a system that allows the simultaneous management of documents in electronic format among a plurality of users.

Communication systems are known which allow multiple users to manage a resource in a shared way, for example a file containing the text of a document. Typically, one user prepares the draft of a document and sends it, by using one of the various telematic communication channels that are known in the art, to a second user for verification, revision and approval. The second user accepts, refuses or reports any inconsistencies or aspects on which he believes intervention is necessary. The document is then modified by the second user and sent again to the first user, who can thus check which modifications have been made to the original document and in turn revise the document again.

Systems are also known which allow a user of a remote computer to work on a local computer and accordingly on a local document. Systems are also known which allow two remote users, each having similar intervention possibilities, to work on a same document within a software application.

However, these approaches are not always applicable. On the one hand, one is unable to differentiate the role of the users, i.e., establish which sets of operations are allowed to each of the users. All users in fact can modify the document at will.

For example, a lawyer might prepare a draft of a contract, which requires qualifications in the legal field, and send it by email to the client. The lawyer needs to obtain the opinion of the client but without allowing him to modify directly any part of the document, since the client does not have the skills needed for this task. The client views the document and, if he approves it, informs the lawyer accordingly. On the other hand, the client should have the assurance that the document that he undersigns has not then been altered after his approval. Accordingly, the “virtual” and electronic step of the exchange of the document, for example by email, is typically followed by a “real” step, which ends with a meeting among the users, during which the entire draft is reread, approved and undersigned, thus reducing or limiting in practice the benefits of remote virtual communication.

The aim of the present invention is to overcome the limitations of the background art noted above, devising a new system capable of allowing management activity on one or more documents that is totally remote, making it possible to attain a final document, with assurance of its integrity, without a real meeting among the users.

Within this aim, an object of the present invention is to allow a document management that is differentiated according to the users.

A further object of the invention is to provide a system that allows users to work on the document and makes it possible to view in a synchronized manner the modifications proposed for the document.

Another object of the present invention is to allow multiple users to work simultaneously on a document.

This aim and these and other objects that will become more apparent hereinafter are achieved by a system for defining and sharing a document in electronic format, comprising a master electronic device and at least one slave electronic device, each of which comprises at least one processing unit, a display for displaying the document and means for telematic data exchange, wherein the master and slave devices are configured to show simultaneously a same view of the document on the corresponding displays; the master device comprises processing means for modifying the document, and the slave device comprises means for applying a digital signature on said document.

This aim and these and other objects that will become better apparent hereinafter are also achieved by a method for sharing information, particularly suitable for the remote management of information technology documents, comprising the steps of connecting a master electronic device and at least one slave electronic device via a telematic network, said devices comprising at least one processing unit, a screen, data exchange means and means for the simultaneous viewing of the document on the screen; processing, on the part of the master device, the document; providing, on the part of at least one slave device, a digital signature; rendering the document non-modifiable once the master device has verified the reception of the digital signature.

The system provides means for the modification and processing of documents also on the slave side; the authorizations to modification and processing are controlled by the master device.

Further characteristics and advantages of the invention will become more apparent from the detailed description that follows, given by way of non-limiting example and accompanied by the corresponding figures, wherein:

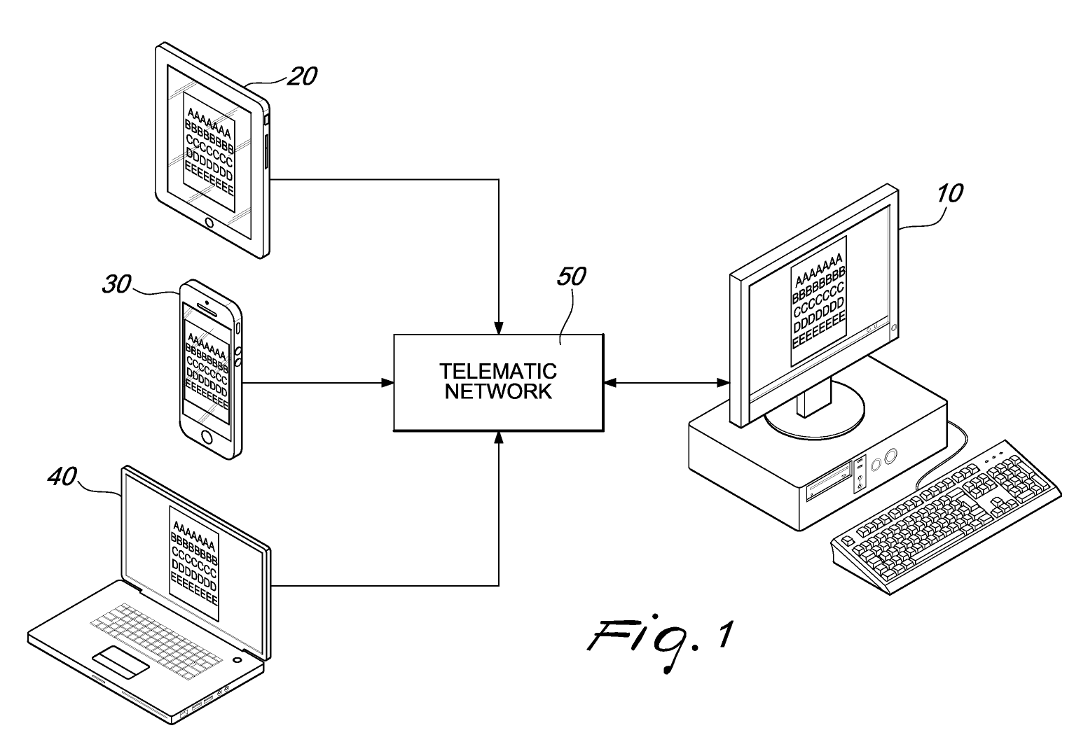

FIG. 1 is a block diagram of the system according to the present invention;

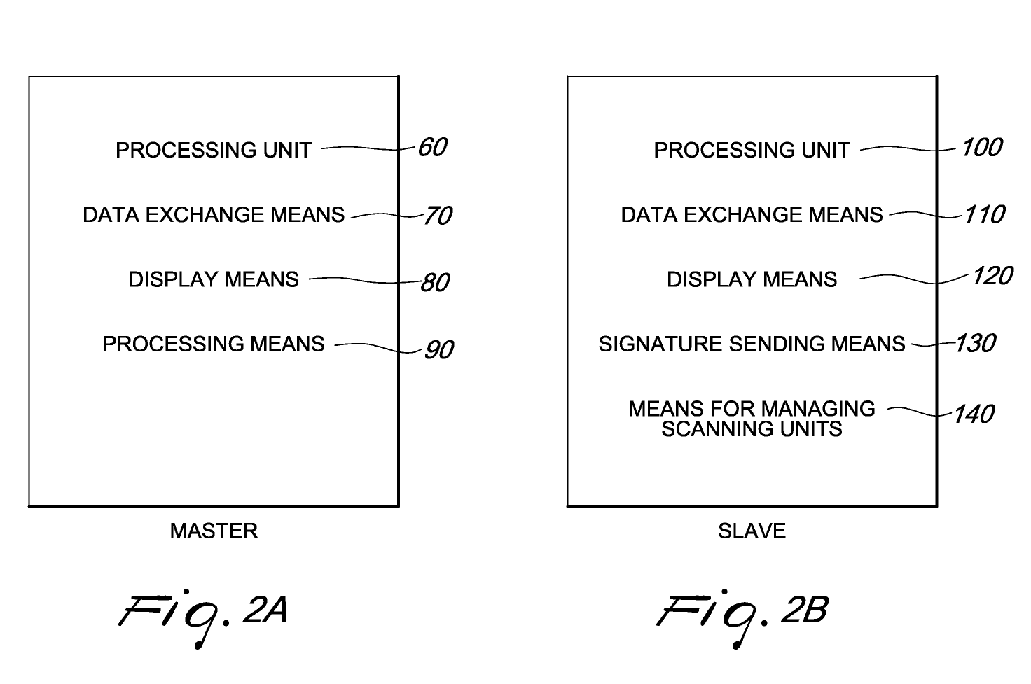

FIG. 2a is a block diagram that explains in greater detail an aspect of the system of FIG. 1;

FIG. 2b is a block diagram that explains in greater detail a second aspect of the system of FIG. 1;

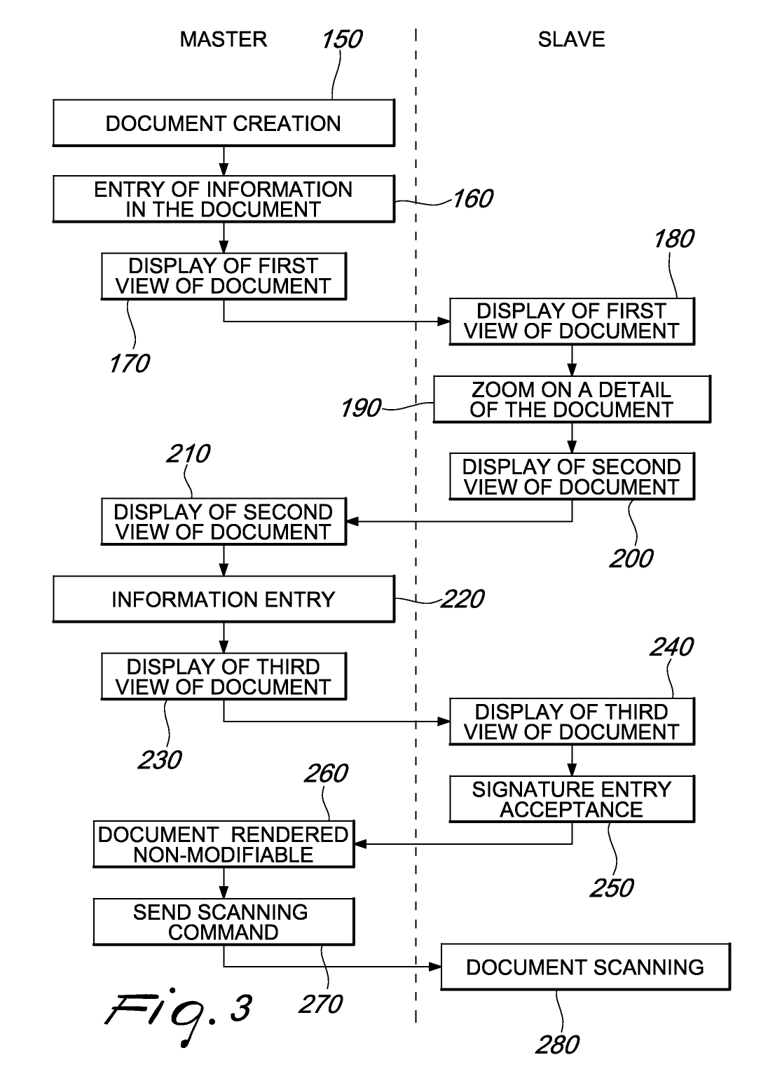

FIG. 3 is a flowchart that explains the operation of the system according to the present invention.

An exemplifying architecture of the system according to the present invention is summarized in the block diagram of FIG. 1.

Said figure shows a first computer 10, which is termed “master” for the sake of convenience in description, a plurality of second computers 20, 30, 40, each referenced here as “slave”, and a telematic network 50.

The master computers 10 and the slave computers 20, 30, 40 represent electronic computers of a known type, in particular personal computers for generic use, which can be programmed to perform arithmetic or logic operations.

In particular, in the context of the present invention, the computers may be not only traditional computers but also tablets, smartphones or other devices that comprise a central processing unit (CPU) and memory.

Moreover, such computers also comprise peripherals that allow retrieval of information from an external source 10, 20, 30, 40. The computers also comprise a screen to display information and means for communication over a telematic network 50.

Some details of implementation and the differences between the computer of the master type and the computer of the slave type will become more apparent with reference to FIGS. 2a and 2b.

Although FIG. 1 shows a plurality of slave computers, the system according to the present invention is exemplified here in the presence of a single slave computer and of a master computer. The person skilled in the art understands without effort that the mechanism described hereafter can be applied in any case also in a context with multiple computers, such as the one exemplified in the figure.

The telematic network 50 is of a known type and is adapted to establish an information technology link among the computers 10, 20, 30 and 40. These links can be provided by means of communications of the TCP/IP or UDP/IP type and implemented for example by means of commercially available technologies such as Windows Communication Foundation (WCF) or with communications technologies based on Web Services or equivalents. The link used can be of any type, so long as it is suitable to allow the exchange of the document and the sending of commands. On the master side of the link there are means for defining the content of the document and saving the document. These functionalities, as will become more apparent hereinafter, are instead absent on the slave side of the link. The document can be of any format, preferably of the PDF or equivalent type.

FIG. 2a is a block diagram of the master computer 10.

The computer of the master type comprises a processing unit 60, data exchange means 70, display means 80 and processing means 90.

The processing unit 60 comprises typically a central processing unit (CPU) and some form of memory.

The data exchange means 70 can be provided for example with WCF technology, i.e., a net technology that allows a process to run methods of another process, even a remote one, and to receive events from another process, even a remote one.

The display means 80 are adapted to modify the visual characteristics of the document. On the master side, the display offers a graphical interface in which there is a plurality of icons, each of which corresponds to a given command.

Typically, a user selects an icon and the corresponding command is sent on the slave side. For example, an icon might be associated with the zoom operation, in order to make it possible to highlight a given part of a document. The zoom command is sent on the slave side and received by the display 120, which accordingly enlarges said document part. In this manner, both on the master computer and on the slave computer it is possible to display a specific part of the document.

The visualizations are preferably adapted to the dimensions of the monitors or of the displays that are present at the two ends of the communication, so as to visualize the document with a different enlargement, adequate to the possible different dimensions of the screens of the computers involved.

The processing means 90 comprise means adapted to modify the content of the document. These means make it possible to add elements to the document, such as images, for example taxpayer identification codes, logos, symbols, photographs and so forth, or other objects, for example a bar code, preferably in the PDF format or the like.

The means 90 further comprise means adapted to enter a signature, particularly provided by the user on the slave side. These digital signatures can be certified with a level of security that is variable and can be generated by means of applications that are commercially available, according to methods that are known in the art.

The computer of the slave type 20, 30, 40 is of a known type and comprises a processing unit 100, data exchange means 110, display means 120, signature sending means 130 and means for managing scanning units 140.

The processing unit 100 and the data exchange means 110 are equivalent to what has been described with reference to the master computer.

The display means 120 are configured so as to allow the visualization of particular details of the document. In this regard, said means make it possible to perform zooms, rotate the document, highlight sections thereof, and perform scrolling. The document thus displayed is shown simultaneously both on the master side and on the slave side. The display means 120, as well as the display means 80, can be provided by means of commercially available software libraries, such as for example the Gdpicture.net library or equivalents.

In FIG. 3, a flowchart is shown which explains operation of the system according to the present invention.

In step 150, the master computer creates a document to be subjected to the visualization and approval of a user.

In step 160, the master computer 10 modifies the document, entering additional information thereto.

In step 170, the document is displayed on the screen of the master computer and simultaneously, minus the negligible delay that can be due to communication over a telematic network, is displayed on the screen of the slave computer, in step 180.

In step 190, the user of the slave computer chooses to display a detail of the document, for example a particular clause. Therefore he performs a zoom operation on the document, which accordingly appears enlarged in step 200. The second view of the document is presented simultaneously on the screen of the master computer 10 in step 210.

In step 220, the user of the master computer 10 selects a portion of the document and enters additional information.

In step 230, the third view of the document is displayed almost simultaneously on the slave side in step 240. The user of the computer on the slave side accepts the document and provides his signature in step 250, confirming this acceptance. The signature can be generated by using commercial libraries that are known in the art, such as Namirial's “Firma Certa” library, or another library, generating an event when a signature is required.

In step 260, the signature is applied to the document, which at that point the system renders non-modifiable.

In step 270, the slave computer sends a scanning command. This functionality allows the master side to control a scan on the slave side, in step 280, by means of a scanner that is connected to the PC of the slave side.

Preferably, the system is configured to allow, at the end of this step, optional operations to modify the composition of the document. For example, without the need to perform again scanning operations that have already been performed, the system allows the acquisition of missing sheets and optionally the sorting of the entire document.

By doing so, the operation ends, with a modified document being shared by both sides.

It has thus been shown that the described method and system achieve the intended aim and objects. In particular it has been shown that the system thus conceived makes it possible to overcome the qualitative limitations of the background art by means of a system that allows the remote communication and processing of a document. In particular, the system thus conceived allows two or more parties to show or propose modifications to the contents or to request the mandatory insertion of content or elements in a document, among these typically the signature.

In one embodiment, the step of adding signatures to the document can be adapted further so that the required signatures are obtained by means of adapted apparatuses, for example tablets connected to the computers. In this case, upon application of the signature, the apparatus can show a reduced portion of the document, which corresponds to the area where the user is required to apply his signature. At the same time, each of the screens of the computers can be configured to show the page on which the signature is to be applied. Preferably, the area in which the signature is required appears highlighted or colored. Additionally, the view of the area shown by the apparatus for applying the signature can be shown, reduced in size, also on the screens of the computers.

The application of the signature can occur on one or more pages comprised within the document. In this case, the pages of the computers on which said signatures are applied and the corresponding highlighted areas can be shown simultaneously and in a synchronized manner with respect to the pages with the request for signatures shown on the apparatuses for signature acquisition.

Preferably, the areas on which the signatures have already been applied can appear highlighted with a different color, so as to render the area where the signature still has to be applied immediately identifiable.

The provision of this synchronized display can be achieved by means of an exchange of information among the computers, using conventional libraries for the management of digital signature apparatuses, for example the “Firma Certa” library of the Namirial company. Said libraries generate an event when a signature is required, and this event commands the display of the pages in the ways described above.

Clearly, numerous modifications are evident and can be performed promptly by the person skilled in the art without abandoning the protective scope of the present invention.

For example, it is obvious to the person skilled in the art that the same functionalities of the system can be provided also among a number N of computers, in which one is master and the remaining ones are slaves. In this case, the master controls the displays and the permissions that each slave has on the document.

Therefore, the scope of the protection of the claims must not be limited by the illustrations or preferred embodiments shown in the description by way of example, but rather the claims must comprise all the characteristics of patentable novelty that reside in the present invention, including all the characteristics that would be treated as equivalents by the person skilled in the art.

The disclosures in Italian Patent Application No. MI2013A000371 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. A system for defining and sharing a document in electronic format, comprising:
a master electronic device and at least one slave electronic device, each one of the master and slave devices comprising at least one processing unit, a display for displaying the document and means for telematic data exchange,
wherein the master and slave devices are configured to show simultaneously a same view of the document on the displays,
wherein the master device comprises processing means for modifying the document, and
wherein the at least one slave device comprises means for applying a digital signature on the document.

12. The system according to claim 11, wherein the processing means of the master are configured to verify the reception of the digital signature and to render the document non-modifiable.

13. The system according to claim 11, wherein the master and slave devices comprise a graphical interface that comprises a plurality of selectable icons, each associated with a command for modifying the display characteristics of the document.

14. The system according to claim 13, wherein the graphical interface of the master device comprises icons for adding information to the content of the document.

15. The system according to claim 14, wherein the processing unit of at least one of the electronic devices is further configured to detect the selection of at least one of the icons and to send the command associated with the icons to the display means of the slave device and to generate and send over the telematic network encoded information that contains the command.

16. The system according to claim 15, wherein the processing unit of the electronic devices is furthermore configured to receive the encoded information and, on the basis of the information, send a command to modify the visual characteristics of the document.

17. The system according to claim 16, wherein the information is encoded and sent by means of WCF technology.

18. The system according to claim 11, wherein the view of the document is resized on the basis of the dimensions of the screens.

19. The system according to claim 11, wherein the at least one slave device further comprises a scanner and the master device is adapted to generate information containing a command to scan the document and send the information to the at least one slave device.

20. A method for sharing information, particularly suitable for the management of information technology documents, the method comprising:
connecting a master electronic device and at least one slave electronic device via a telematic network, the devices comprising at least one processing unit, a screen, data exchange means and means for the simultaneous viewing of the document on the screen;
processing, on the part of the master device, the document;
providing, on the part of at least one of the slave devices, a digital signature;
rendering the document non-modifiable once the master device has verified the reception of the digital signature on the part of the at least one slave device.
